(19) United States
(12) Patent Application Publication
(10) Pub. No.: US 2026/0147826 A1
(43) Pub. Date: May 28, 2026

(54) APPARATUS, METHOD, AND SYSTEM FOR PROVIDING NEURO-SYMBOLIC EXPERT MACHINE LEARNING MODEL SELECTION

(71) Applicant: Nokia Solutions and Networks Oy, Espoo (FI)

(72) Inventors: Jacky CAO, Espoo (FI); Maryam SABZEVARI, Espoo (FI)

(21) Appl. No.: 19/390,178

(22) Filed: Nov. 14, 2025

(30) Foreign Application Priority Data
Nov. 26, 2024 (FI) 20246386

(51) Int. Cl. G06F 16/532; G06F 16/901

(52) U.S. Cl. CPC G06F 16/532; G06F 16/9024

(57) ABSTRACT

An approach is provided for neuro-symbolic expert machine learning model selection. The approach, for example, involves applying a first machine learning model to perform a first keypoint extraction and/or detection of at least one object of one or more object classes in image data. The approach further involves querying a database of a plurality of expert models for a second machine learning model based on the one or more object classes of the first keypoint extraction and/or detection. The second machine learning model is an expert model trained to detect the one or more object classes or another object class related to the one or more object classes, and the database corresponds to a hierarchical structure that relates the plurality of expert models based, at least in part, on a plurality of object class labels.

### FIELD

The disclosed subject matter generally relates to using adaptive data and model sharing in a neuro-symbolic artificial intelligence (AI) system (e.g., machine learning (ML) neural network models combined with symbolic representations) for computer vision algorithms which analyze environment data streams (e.g., image frames) for use cases such as extended reality (XR) and simultaneous localization and mapping (SLAM) applications.

### BACKGROUND

Extended reality (XR) systems generally perform the computer vision task of simultaneous localization and mapping (SLAM). Namely, the process of simultaneously creating environment maps and localizing agents within those maps. Incorporating SLAM into XR pipelines is useful as holograms can then be more accurately placed and tracked within the environment. In a client-server XR system, one way to distribute the SLAM components is placing its entirety on a server and have clients transmit images. However, this could end up producing network congestion and degrade the overall XR experience which leads to the challenge of optimizing the client-server data sharing for XR.

### SOME EXAMPLE EMBODIMENTS

Therefore, there is a need for providing adaptive data sharing in simultaneous localization and mapping (SLAM), e.g., in a client-server architecture.

According to one example embodiment, an apparatus comprises means for applying a first machine learning model to perform a first keypoint extraction and/or a first detection of at least one object of one or more object classes in image data. The apparatus also comprises means for querying a database of a plurality of expert models for a second machine learning model based on the one or more object classes of the first keypoint extraction and/or the first detection. The database includes, for instance, a hierarchical structure that relates the plurality of expert models based, at least in part, on a plurality of object class labels. The second machine learning model is an expert model trained to detect the one or more object classes or another object class related to the one or more object classes. The apparatus is further caused to perform applying the second machine learning model to perform a second keypoint extraction and/or a second detection of the at least one object of the one or more object classes in the image data.

According to another embodiment, an apparatus comprises at least one processor, and at least one memory storing instructions that, when executed by the at least one processor, cause the apparatus at least to perform applying a first machine learning model to perform a first keypoint extraction and/or a first detection of at least one object of one or more object classes in image data. The apparatus is also caused to perform querying a database of a plurality of expert models for a second machine learning model based on the one or more object classes of the first keypoint extraction and/or the first detection. The database includes, for instance, a hierarchical structure that relates the plurality of expert models based, at least in part, on a plurality of object class labels. The second machine learning model is an expert model trained to detect the one or more object classes or another object class related to the one or more object classes. The apparatus is further caused to perform applying the second machine learning model to perform a second keypoint extraction and/or a second detection of the at least one object of the one or more object classes in the image data.

According to another embodiment, a method comprises applying a first machine learning model to perform a first keypoint extraction and/or a first detection of at least one object of one or more object classes in image data. The method also comprises querying a database of a plurality of expert models for a second machine learning model based on the one or more object classes of the first detection. The database includes, for instance, a hierarchical structure that relates the plurality of expert models based, at least in part, on a plurality of object class labels. The second machine learning model is an expert model trained to detect the one or more object classes or another object class related to the one or more object classes. The method further comprises applying the second machine learning model to perform a second keypoint extraction and/or a second detection of the at least one object of the one or more object classes in the image data.

According to another embodiment, a computer program comprising instructions which, when executed by an apparatus, cause the apparatus to perform applying a first machine learning model to perform a first keypoint extraction and/or a first detection of at least one object of one or more object classes in image data. The apparatus is also caused to perform querying a database of a plurality of expert models for a second machine learning model based on the one or more object classes of the first detection. The database includes, for instance, a hierarchical structure that relates the plurality of expert models based, at least in part, on a plurality of object class labels. The second machine learning model is an expert model trained to detect the one or more object classes or another object class related to the one or more object classes. The apparatus is further caused to perform applying the second machine learning model to perform a second keypoint extraction and/or a second detection of the one or more object classes in the image data.

According to another embodiment, a non-transitory computer-readable storage medium comprising program instructions that, when executed by an apparatus, cause the apparatus to perform applying a first machine learning model to perform a first keypoint extraction and/or a first detection of at least one object of one or more object classes in image data. The apparatus is also caused to perform querying a database of a plurality of expert models for a second machine learning model based on the one or more object classes of the first detection. The database includes, for instance, a hierarchical structure that relates the plurality of expert models based, at least in part, on a plurality of object class labels. The second machine learning model is an expert model trained to detect the one or more object classes or another object class related to the one or more object classes. The apparatus is further caused to perform applying the second machine learning model to perform a second keypoint extraction and/or a second detection of the at least one object of the one or more object classes in the image data.

According to one example embodiment, an apparatus comprises circuitry configured to perform applying a first machine learning model to perform a first keypoint extraction and/or a first detection of at least one object of one or more object classes in image data. The circuitry is also configured to perform querying a database of a plurality of expert models for a second machine learning model based on the one or more object classes of the first detection. The database includes, for instance, a hierarchical structure that relates the plurality of expert models based, at least in part, on a plurality of object class labels. The second machine learning model is an expert model trained to detect the one or more object classes or another object class related to the one or more object classes. The circuitry is further configured to perform applying the second machine learning model to perform a second keypoint extraction and/or a second detection of the at least one object of the one or more object classes in the image data.

According to a further embodiment, a device comprises at least one processor; and at least one memory including a computer program code for one or more programs, the at least one memory and the computer program code configured to, with the at least one processor, cause the device to perform applying a first machine learning model to perform a first keypoint extraction and/or a first detection of at least one object of one or more object classes in image data. The device is also caused to perform querying a database of a plurality of expert models for a second machine learning model based on the one or more object classes of the first detection. The database includes, for instance, a hierarchical structure that relates the plurality of expert models based, at least in part, on a plurality of object class labels. The second machine learning model is an expert model trained to detect the one or more object classes or another object class related to the one or more object classes. The device is further caused to perform applying the second machine learning model to perform a second keypoint extraction and/or a second detection of the at least one object of the one or more object classes in the image data.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing a method of the claims.

According to some aspects, there is provided the subject matter of the independent claims. Some further aspects are defined in the dependent claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The example embodiments of the invention are illustrated by way of examples, and not by way of limitation, in the figures of the accompanying drawings:

FIG. 1 is a diagram of a system capable of providing neuro-symbolic expert machine learning (ML) model selection, according to one example embodiment;

FIG. 2 is a diagram illustrating an initial set of keypoints generated from a general extraction model, according to one example embodiment;

FIG. 3 is a diagram illustrating object detection applied to image data, according to one example embodiment;

FIG. 4 is a diagram illustrating an example knowledge graph based on detected objects from a scene, according to one example embodiment;

FIG. 5 is a diagram illustrating an example expert models database, according to one example embodiment;

FIG. 6. is a diagram illustrating an extended knowledge graph/hierarchical structure containing children and parent objects and their relationships, according to one example embodiment;

FIG. 7 is a diagram illustrating an example of applying expert models for keypoints extraction, according to one example embodiment;

FIG. 8 is a flowchart of a process for neuro-symbolic-based expert model selection, according to one example embodiment;

FIG. 9 is a diagram of hardware that can be used to implement example embodiments; and

FIG. 10 is a diagram of a chip set that can be used to implement example embodiments.

### DESCRIPTION OF SOME EMBODIMENTS

Examples of a method, apparatus, and computer program for providing neuro-symbolic expert machine learning (ML) model selection, according to one example embodiment, are disclosed in the following. In the following description, for the purposes of explanation, numerous specific details and examples are set forth to provide a thorough understanding of the embodiments of the invention. It is apparent, however, to one skilled in the art that the embodiments of the invention may be practiced without these specific details or with an equivalent arrangement. In other instances, structures and devices are shown in block diagram form to avoid unnecessarily obscuring the embodiments of the invention.

Reference in this specification to “one embodiment”, “one example embodiment”, “an “embodiment”, or “an example embodiment” means that a particular feature, structure, or characteristic described in connection with the embodiment is included in at least one embodiment of the present disclosure. The appearance of the phrase “in one embodiment” or “in one example embodiment” in various places in the specification are not necessarily all referring to the same example embodiment, nor are separate or alternative example embodiments mutually exclusive of other embodiments. In addition, the embodiments described herein are provided by example, and as such, “one embodiment” can also be used synonymously as “one example embodiment.” Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

As used herein, “at least one of the following: <a list of two or more elements>,” “at least one of <a list of two or more elements>,” “<a list of two or more elements> or a combination thereof,” and similar wording, where the list of two or more elements are joined by “and” or “or”, mean at least any one of the elements, or at least any two or more of the elements, or at least all the elements.

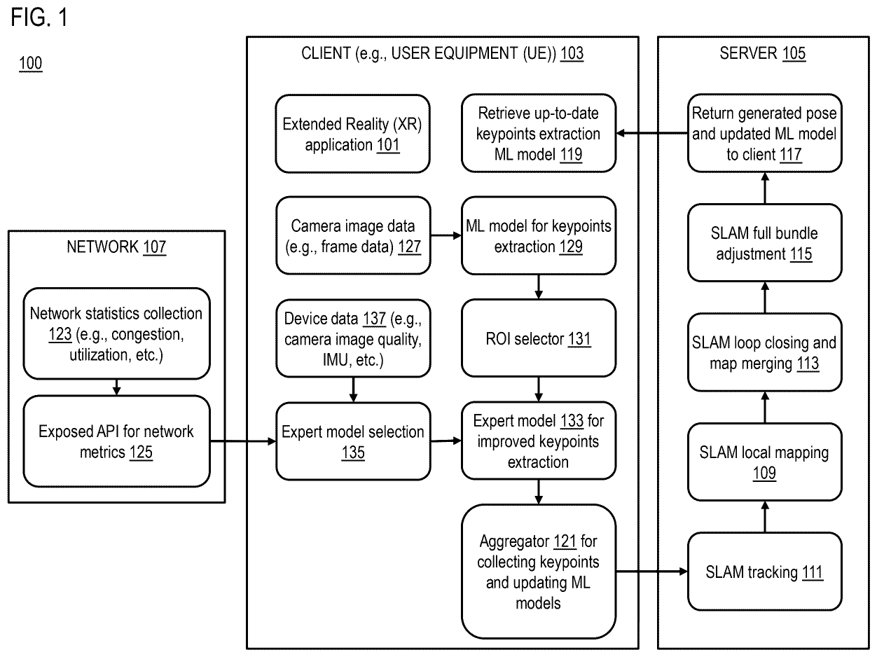

FIG. 1 is a diagram of a system 100 capable of providing neuro-symbolic expert ML model selection, according to one example embodiment. Extended reality (XR) applications (e.g., XR application 101 executing a client/user equipment (UE) device 103) enhance the physical world by overlaying user views with virtually drawn holograms and annotations. The computer vision algorithms which analyze environment data streams for the XR applications 101 are generally not executed on-device (e.g., on client/UE 103), since XR applications 101 usually have stringent quality of service (QoS) requirements and user devices 103 have limited computation power. Computation offloading is suitable for overcoming these issues where resource intensive algorithms are moved from user devices (UEs 103) to external nodes with more computation power (e.g., cloud or edge servers such as a server 105) over a communication/data network 107. With computer vision, the images from device cameras need to be transmitted from client (e.g., UE 103) to server (e.g., server 105). However, this transmission could lead to network link saturation, and with a multi-client system, this could create substantial network congestion. Therefore, there is a need to optimize the data sharing in an XR system (e.g., system 100) to ensure that XR applications 101 can meet their requirements while not impacting other users.

In one embodiment, the system 100 which performs the computer vision task of simultaneous localization and mapping (SLAM). Namely, the process of simultaneously creating environment maps (e.g., SLAM local mapping 109) and localizing agents within those maps (e.g., SLAM tracking 111). Incorporating SLAM into XR pipelines is useful as holograms can then be more accurately placed and tracked within the environment. In a client-server XR system (e.g., system 100), one way to distribute the SLAM components (e.g., image processing for keypoint extraction, SLAM local mapping 109, SLAM tracking 111, SLAM loop closing and map merging 113, SLAM full bundle adjustment 115, and returning pose and updated ML models 117) is placing its entirety on a server 105 and have clients/UEs 103 transmit images. However, as stated, this could end up producing network congestion and degrade the overall XR experience which leads to the challenge of optimizing the client-server data sharing for XR.

However, service provides face technical challenges with respect to improving frame features extraction (e.g., keypoints) from images (e.g., image frame data 127) on client devices 103. These features are used as part of an XR system/application 101 which configure clients 103 to offload data to a server 105, where the server 105 hosts a SLAM algorithm and uses input data (e.g., extracted keypoints data) from clients 103. Conventional approaches demonstrate the use of lightweight neural networks (NNs) to perform the task of feature extraction. However, the models used are typically generalized and trained to be all-purpose, meaning that in some environments (e.g., ones with unknown objects, or a lot of objects), they may fail to accurately extract features from scenes, leading to a degradation of the SLAM tracking. Accordingly, there are significant technical challenges to supplementing this general set of features (e.g., features extracted using a generalized feature extraction model with extraction results obtained from more-specified “expert” models.

To solve these technical challenges, the system 100 of FIG. 1 introduces a capability to incorporating a novel neuro-symbolic AI-based mechanism to intelligently select expert models based on the objects or object classes recognized in the current scene. In the context of machine learning-based object detection or feature extraction, an object/feature refers to a specific instance of an item/feature that is present within an image or a scene, such as a particular car, tree, or person. On the other hand, an object class denotes a broader category to which the object belongs, encompassing all possible instances of such items. For example, “car” is an object class that includes all cars regardless of their make, model, or color. While object detection algorithms identify and localize objects within a scene, they also classify these objects into their respective object classes, ensuring that each detected instance is correctly categorized according to the pre-defined labels used during the training of the model.

In one embodiment, the system 100 uses a neuro-symbolic methodology, where clients 103 can keep their lightweight general feature extraction models (e.g., initial ML. mode for keypoints extraction 129) but supplement them using specialized lightweight expert models (e.g., expert model 133) retrieved from a server 105. In this way, clients 103 are not required to host either a very complex general extraction model or a large selection of expert models. The former may require a large amount of storage and computation power to execute, and there could be scenarios where the latter is not sufficient as the on-device expert models collection may be incomplete. Instead, the clients 103 can perform adaptive model selection to retrieve and utilize the models which are most relevant for itself based on the environment.

By way of example, a general model for feature extraction is designed to recognize and extract a wide range of features from various environments, regardless of the specific objects or scenes present. It is trained to be all-purpose, making it versatile but sometimes less accurate in specific scenarios. In contrast, an expert model for feature extraction is specialized to detect particular features (e.g., objects or keypoints) or types of features (e.g., object classes) with higher specificity and accuracy. These expert models are fine-tuned to recognize subtle details within specific object classes or environments, leading to more precise feature extraction in those targeted contexts.

In one embodiment, the term general model and expert model can be relative in that the expert model is defined as any model having detection performance characteristics that are better than the model that is labeled as the general model. For example, in the context of machine learning-based object detection, several performance metrics can be used to evaluate the effectiveness of feature detection model including but not limited to precision and recall. Precision measures the accuracy of the detected features by evaluating the proportion of true positive detections out of all positive detections, while recall assesses the model's capability to identify all relevant features by measuring the proportion of true positives out of all actual positives. The F1-score, a harmonic mean of precision and recall, provides a single metric that balances the two. Additionally, Intersection over Union (IoU) quantifies the overlap between the predicted bounding boxes and the ground truth, reflecting the accuracy of localization. Mean Average Precision (mAP) aggregates the precision-recall curve to provide a comprehensive evaluation of the model's performance across different levels of recall. Lastly, computational efficiency metrics, such as inference time and memory usage can also be used for assessing the model's performance with respect to real-time and resource-constrained applications.

The invention uses neuro-symbolic AI on clients 103 (e.g., by creating knowledge graphs of detected features/objects) to summarize the scenes and environments around XR users, and then selects expert models to perform improved features extraction from frames. The system 100 of FIG. 1 illustrates one example of an XR system which implements the various embodiments of this neuro-symbolic AI based expert model selection. As shown, the server 105 hosts most of the SLAM components (e.g., SLAM tracking 111, SLAM local mapping 109, SLAM loop closing and map merging 113, SLAM full bundle adjustment 115, etc.) and uses keypoint features that are extracted and transferred from the client 103. In one embodiment, clients 103 do not transmit images (e.g., image frame data 127) from themselves as this would require significant bandwidth and time. Instead, keypoint extraction (e.g., ML model for keypoints extraction 129) is performed on-device and the combined results of the general and expert models are smaller in size than that of the images.

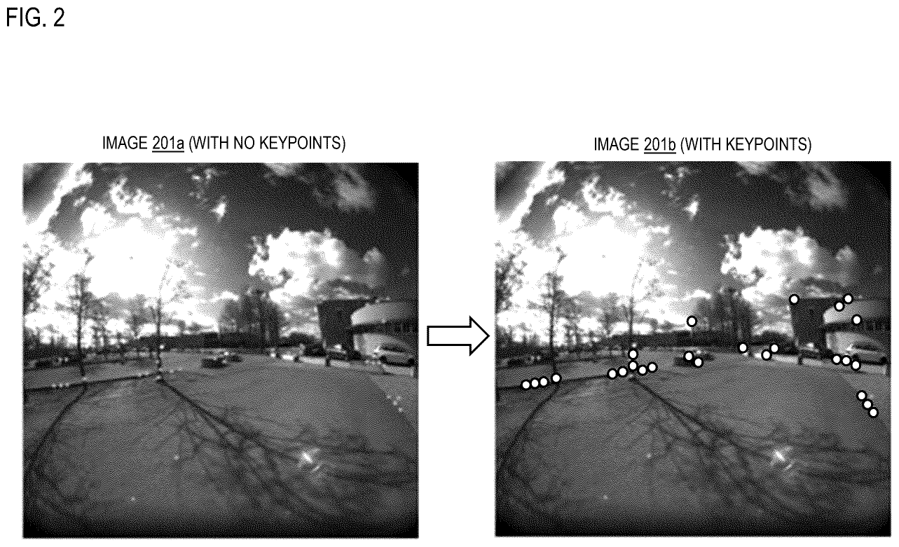

For example, before expert models (e.g., expert model 133) are selected, the client 103 uses a lightweight general model to extract an initial set of keypoints (e.g., ML model for keypoints extraction 129) from images (e.g., image frame data 127 captured from one or more camera sensors of the client 103). FIG. 2 is a diagram of an example of a device-captured image 201a without keypoints, and the initial set of keypoints (e.g., indicated as white dots in image 201b with keypoints) generated from a general extraction model, according to one example embodiment. In this example, the captured image 201 is from the world-facing camera of a smartphone, head mounted device, and/or the like.

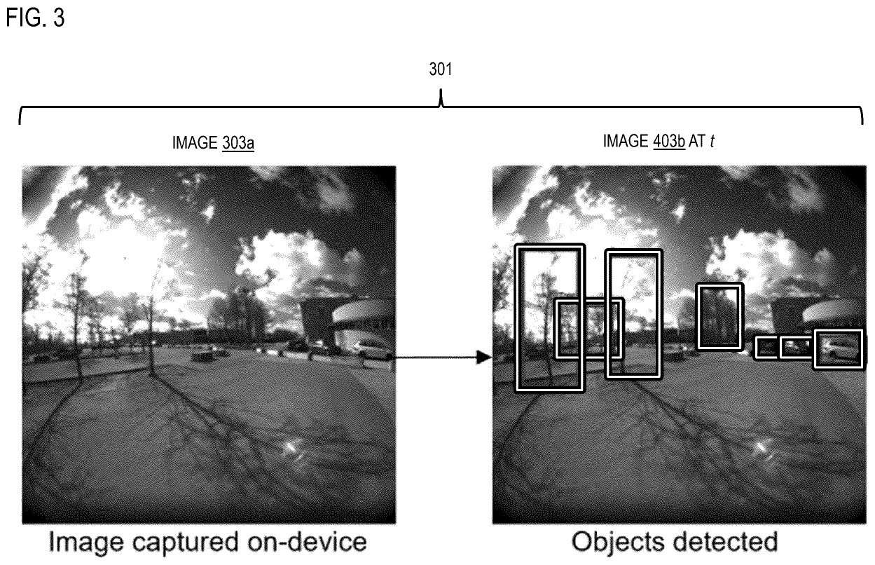

In one embodiment, the initial keypoints are temporarily held in memory, or the following occurs in parallel with, e.g., the expert model 133 selection. The initial step in the expert model 133 selection is to perform object detection on the image frame to extract the labels of the objects recognized in the scene. FIG. 3 is a diagram illustrating object detection applied to image data 301, according to one example embodiment. In this example, the image data 301 includes an image frame 303a (e.g., an image captured on-device at client 103). Image frame 303b illustrates image from 303a after object detection with detected objects indicated by bounding boxes shown as white rectangles. Object labels indicated the object class of each detected objects are also determined by ML-based object detection (object labels are not in FIG. 3).

In one embodiment, object detection could happen sequentially (e.g., either before or after the initial keypoints extraction). In other embodiments, to reduce the amount of computation and models needed, both keypoint extraction and object detection could potentially be combined, e.g., by using a model that simultaneously performs object detection and keypoint extraction, and outputs both.

Regardless, in any embodiment, the object labels of the objects are collected. In the context of machine learning-based object detection, object labels refer to the tags or identifiers assigned to various detected objects within an image or a scene. These labels categorize the objects into predefined classes, such as “car,” “tree,” or “person,” providing a structured way to identify and differentiate between the various detected features present. Then, a knowledge graph is constructed using the collected object labels. This graph represents the scene and summarizes the relationship of the different objects detected in the image frame data.

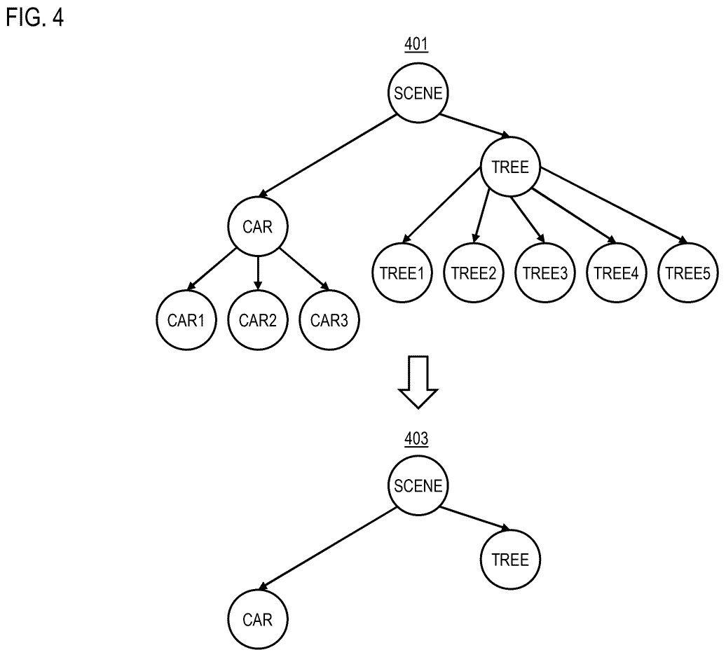

FIG. 4 is a diagram illustrating an example knowledge graph 401 based on detected objects from a scene, according to one example embodiment. In this example, three cars and five trees were detected in the scene of the image frame data. As a result, the knowledge graph 401 has an initial node representing the entire “scene” and sub-nodes representing a “car” object class and a “tree” object class. Under the “car” subnode, three additional subnodes “car1,” “car2,” and “car3,” are added to represent each detected instance of the “car” object class. Similarly, under the “tree” subnode, five additional subnodes “tree1,” “tree2,” “tree3,” “tree4,” and “tree5” are added to represent each detected instance of the “tree” object class.

In one embodiment, a reduced knowledge graph 403 can be reduced from the larger knowledge graph 401 by grouping the objects together by classification (e.g., by object class). In this example, the three “car” detection instances are grouped in the “car” object class, and the five “tree” detection instances are grouped in the “tree” object class. This results in the reduced knowledge graph 403 being much more compact in size than the larger knowledge graph 401 while still providing information on detected object classes. This provides the technical advantages of reduced memory resources for storing the knowledge graph 403 and reduced network resources for transmitting the knowledge graph 403 from the client 103 to the server 105. In other words, the knowledge graph 401 is reduced, and the key object groups/classes are selected. In one embodiment, these groups are stored into a simple text list, encoded, and transmitted to the server 105 as a request for expert models.

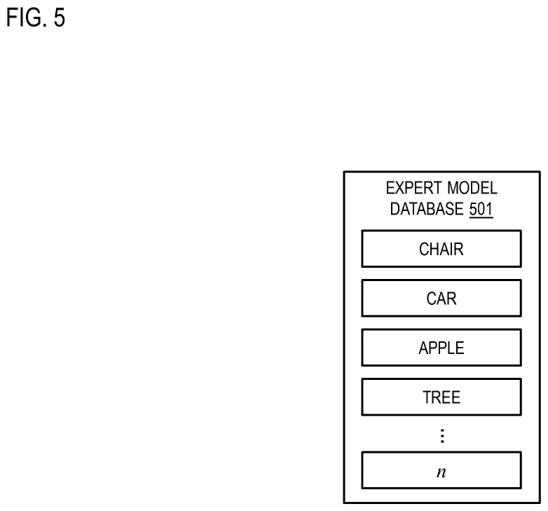

In one embodiment, the server 105 hosts a large database containing a variety of expert models for keypoint extraction. FIG. 5 is a diagram illustrating an example expert models database 501, according to one example embodiment. The expert models database 501 stores expert models for a variety of object classes (e.g., chair, car, apple, tree, etc.).

In one embodiment, the incoming request for one or more expert models from the client 103 is parsed, the required models are selected, and then returned to the client 103. The various embodiments described herein assumes that this expert models database 501 is hosted on the same server 105 which is performing the SLAM computation. However, it is contemplated that the expert models database 501 can be hosted by other equivalent component.

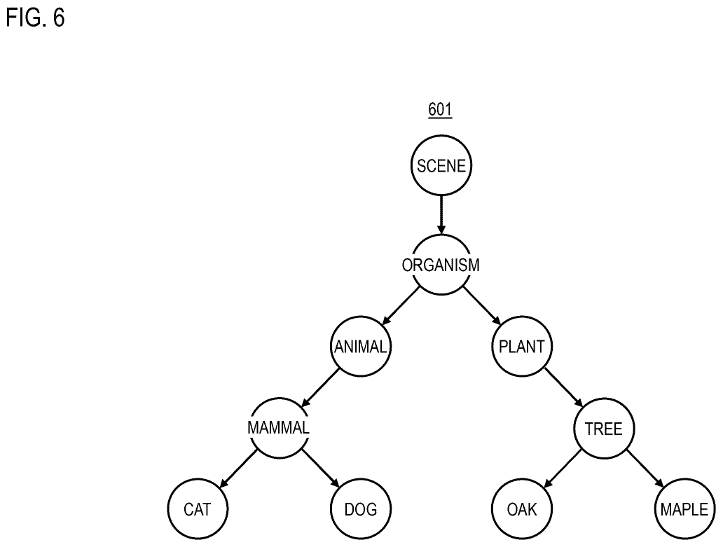

In one embodiment, the database 501 is assumed to contain all necessary expert models. However, if a requesting client 103 wants to retrieve an expert model for an object/object class that the database 501 does not have, then the knowledge graph is re-queried, and the parent or child expert model is used instead. For instance, in the example of FIG. 5, if an expert model is not available for the object “Tree”, then the expert model “Plant” could be retrieved as it is the hierarchical parent to “Tree” in the knowledge graph, as shown in the hierarchical structure 601 of FIG. 6. The extended knowledge graph or hierarchical structure 601 contains additional children and parent objects and their relationships. In this way, the system can continue to provide service even if it is with a more “generalized” expert model (e.g., in the case of obtaining the expert model based on a hierarchical parent) or a more “specialized” expert model (e.g., in the case of obtaining the expert mode based on a hierarchical child).

In one embodiment, the constructed knowledge graph is also not limited to just containing objects. As part of the captured scenes, there are also other characteristics which can describe the content, e.g., the illumination of the scene, the shapes of the objects, the occlusion hierarchy of the objects, whether the scene is indoors or outdoors, etc. By constructing such a knowledge graph, the most suitable expert models can continually be selected for the given scenario and environment, allowing the most optimal keypoints to be extracted.

Once the expert models are returned to the client 103, the client 103 computes the regions-of-interest (ROI) to apply the expert models to (e.g., by using ROI selector 131). The ROIs are based on the bounding boxes extracted during object detection (e.g., bounding boxes as shown in FIG. 3). The ROI selector 131 then applies the expert models to their corresponding object detected regions to extract an improved set of keypoints.

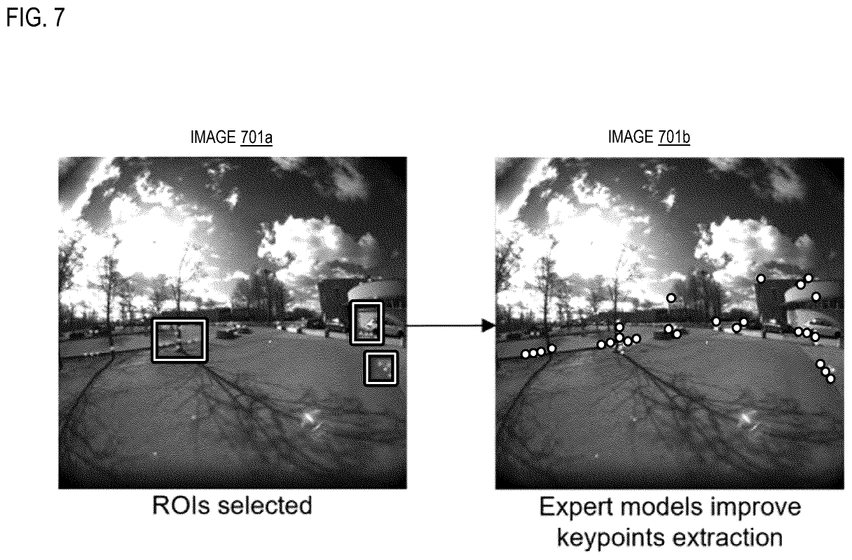

FIG. 7 is a diagram illustrating an example of applying expert models for keypoints extraction, according to one example embodiment. In image 701a, object detection identified three ROIs (e.g., identified by white bounding boxes) corresponding to respective detected objects of different object classes. The ROI selector 131 matches the object class of each ROI to a corresponding expert model for keypoint extraction (e.g., a ROI of object class “Car” is processed using a “Car” expert model, etc.).

In one embodiment, the improved set of keypoints and optionally the initial set are collected using an aggregator 121 and then transmitted to the server 105 to be analyzed by the SLAM pipeline. As part of the SLAM pipeline, the server 105 can return generated pose and updated ML model to the client 103 in process 117 to complete the pipeline.

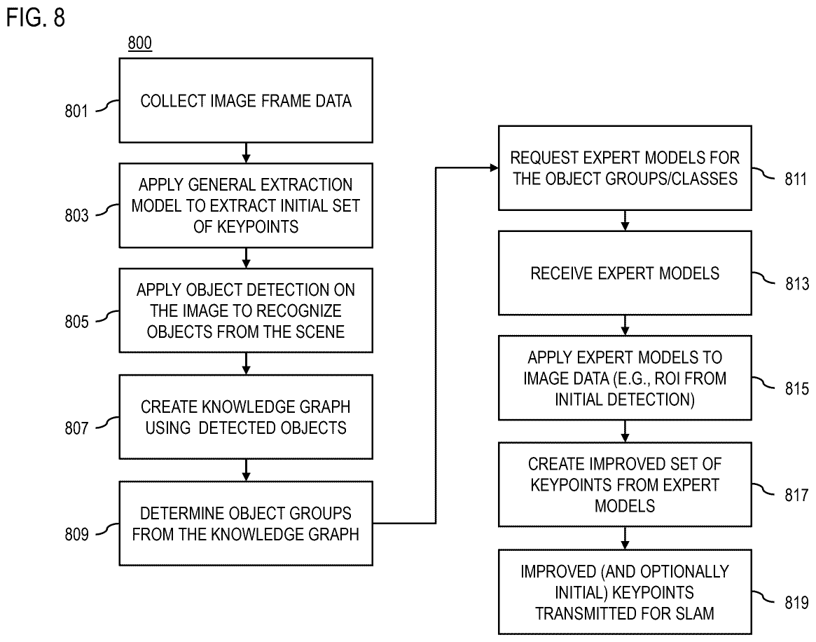

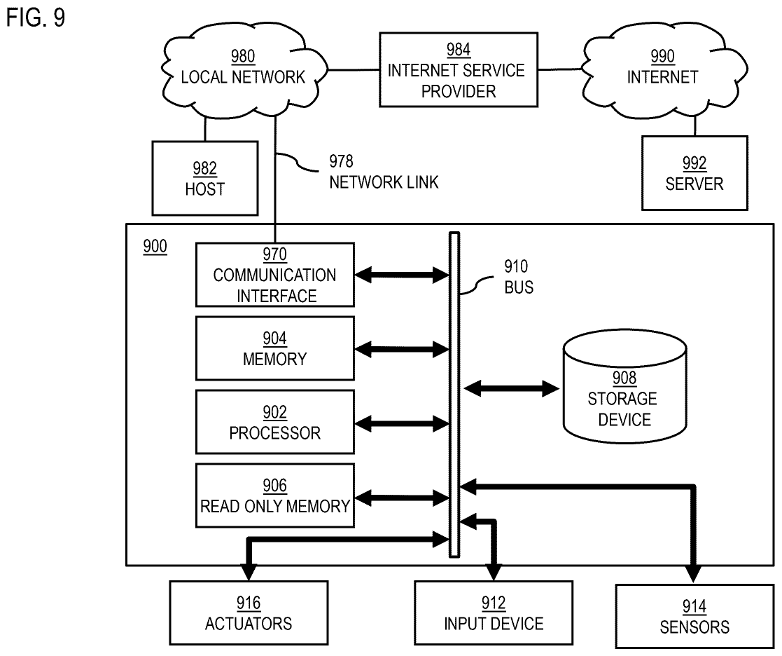

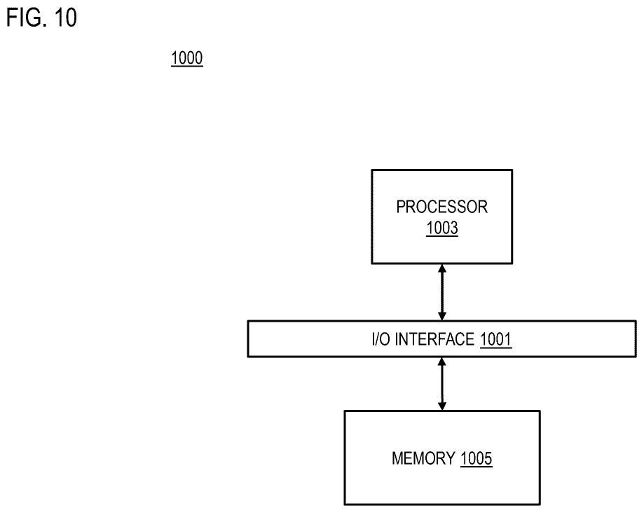

Various embodiments of neuro-symbolic-based expert model selection is further described with respect to FIG. 8. FIG. 8 is a flowchart of a process for neuro-symbolic-based expert model selection, according to one example embodiment. In one example, the system 100 (e.g., via aggregator 121, general extraction model 129, expert model 133) and/or any of its components/circuitry may perform one or more portions of a process 800 and may be implemented in/by various means, for instance, one or more chip sets including a processor and a memory as shown in FIG. 9 or 10 or in a circuitry, hardware, firmware, software, or in any combination thereof. As such, the system 100 and/or any associated component, apparatus, device, circuitry, system, computer program product, method, and/or non-transitory computer readable medium, or any combination thereof, can provide means for accomplishing various parts of the process 800, as well as means for accomplishing embodiments of other processes described herein. Although the process 800 is illustrated and described as a sequence of steps, it is contemplated that various embodiments of the process 800 may be performed in any order or combination and need not include all of the illustrated steps.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular telecom network device, or other computing or network device. In another embodiment, one or more of the components of the system 100 may be implemented as a cloud-based service, local service, native application, or in any combination thereof.

At step 801, the process 800 begins with a client device 103 capturing an image (e.g., image frame data 127) from a world-facing camera. The image frame data 127 (e.g., the first input) is a sequential time series set of image frames taken from client/UE devices 103 (e.g., from a world-facing camera on a smartphone, head mounted device (HMD), etc.).

At step 803, a general extraction model is applied to the captured image to identify and extract an initial set of keypoints. By way of example, keypoints are distinct, identifiable points within an image that are used as reference markers for computer vision tasks such as but not limited to SLAM processing. These points, which may include edges, corners, or blobs, are selected based on their unique features that remain consistent under different viewing conditions. They serve as anchors that allow the SLAM algorithm to recognize and track the same physical locations across multiple image frames. By way of example, commonly used keypoints include but are not limited to Harris corners, SIFT (Scale-Invariant Feature Transform) descriptors, and ORB (Oriented FAST and Rotated BRIEF) features, which are resilient to changes in scale, rotation, and illumination, ensuring robust and reliable mapping and localization.

At step 805, an object detection model is employed to analyze the image and identify objects present in the scene (e.g., objects associated with the extracted keypoints). The model locates (e.g., via bounding boxes) and classifies objects, thereby providing information about their spatial locations and semantic categories (e.g., object classes).

In other words, the system 100 applies a first machine learning model (e.g., comprising multiple sequential models for keypoint extraction and then object detection, or a single model for simultaneous keypoint extraction and objection) to perform a first detection of at least one object of one or more object classes (e.g., associated with the extracted keypoints) in image data.

At step 807, a knowledge graph is constructed based on the detected objects and/or object classes. The graph represents hierarchical semantic relationships between objects, such as semantic similarity, or functional dependencies. This graph provides a structured representation of the scene's content. In other words, the knowledge graph summarizes on or more relationships of one or more detected objects of the one or more object classes.

At step 809, the knowledge graph is analyzed to identify groups of semantically related objects. These object groups represent object classes of the detected instances of the similar objects within the scene.

At process 811, a request is generated for expert models that are tailored to the specific objects/object classes identified in the previous step. In one embodiment, this request is sent to a server database. In another embodiment, the expert models database can be local or otherwise stored on the client device so that the request can be processed on the client device. In other words, the system 100 queries a database (e.g., either on the server or local to the client) of a plurality of expert models for a second machine learning model based on the one or more object classes of the first detection. The second machine learning model is an expert model trained to detect the one or more object classes or another object class related to the one or more object classes detected by the first machine learning model (e.g., a more general object detection model). In one embodiment, the second machine learning model is more specifically than the first machine learning model to detect the one or more object classes of the first detection. For example, training more specifically refers to training the second machine learning model to detect one or more object classes with more precision, recall, etc. than the first machine learning model.

At step 813, in response to the expert model request, the selected expert models are retrieved from the expert models database and transmitted to the client device 105. In one embodiment, the retrieval is facilitated by the knowledge graph which represents a hierarchical structure of object classes. The database corresponds to a hierarchical structure that relates the plurality of expert models based, at least in part, on a plurality of object class labels. For example, the hierarchical structure is based, at least in part, on a generality of the plurality of object class labels (e.g., general object classes are at a higher hierarchical level with child levels/nodes being more specific object classes). As previously described, the hierarchical structure can be based, at least in part, on one or more characteristics which can describe the one or more object classes.

Because of this hierarchical structure, the system 100 can query or re-query the database for the expert model from a hierarchical parent or a hierarchical child of the one or more object classes in the hierarchical structure based, at least in part, on determining that the one or more object classes of the first detection does not have an available expert model in the database, or if expert model returned at the corresponding hierarchical is not to be used.

At step 815, the client device 103 applies the retrieved expert models to regions of interest (ROIs) within the image. These ROIs are defined by the bounding boxes generated during the object detection step. In other words, the first detection (e.g., using the first general model) includes one or more regions of interest in the image data that are associated with the one or more object classes, and then the second machine learning model is applied to the one or more regions of interest to perform the second detection (e.g., using the expert model).

At step 817, the expert models process the ROIs to generate an improved set of keypoints. These keypoints are more accurate and informative than the initial set, as they are specifically tailored to detecting the object classes in the content of each ROI.

At step 819, the initial set of keypoints and the improved set of keypoints are combined into a single, refined set. This combined set of keypoints is then transmitted to the server for further analysis, such as simultaneous localization and mapping (SLAM).

By way of example, the various embodiments described herein have several use-cases in XR. For example, entertainment, gaming, eCommerce, education, and others. With the use-cases of entertainment and gaming, content is traditionally fixed to 2-dimensional displays. XR content can enhance users'experience by allowing them to consume and interact with immersive 3-dimensional content. With sports viewing, with several users in a living room, each with their own XR device, who are all watching the same match of a sport. During the game, there are video, audio, and XR content streams of the action, e.g., from different angles, from the perspective of a referee or player, etc. To enable a collaborative and engaging experience, the XR content in particular, e.g., holograms, should be synchronized to appear in the same locations for each user. This requires SLAM and its ability to map environments and localize content and users within that. Furthermore, there is the stringent requirement of near real-time viewing. Therefore, the various embodiments described herein can support this use-case and more, through its reduction in the amount of data transmitted between clients and servers, and its ability to adapt to evolving network conditions.

Returning to FIG. 1, in one example, the components of the system 100 may communicate over one or more communications networks 107 that includes one or more networks such as a data network, a wireless network, a telephony network, or any combination thereof. It is contemplated that the communications network 107 may be any local area network (LAN), metropolitan area network (MAN), wide area network (WAN), a public data network (e.g., the Internet), short range wireless communications network, or any other suitable packet-switched network, such as a commercially owned, proprietary packet-switched network, e.g., a proprietary cable or fiber-optic network, and the like, or any combination thereof. In addition, the communications network 107 may be, for example, a cellular telecom network and may employ various technologies including enhanced data rates for global evolution (EDGE), general packet radio service (GPRS), global system for mobile communications (GSM), Internet protocol multimedia subsystem (IMS), universal mobile telecommunications system (UMTS), worldwide interoperability for microwave access (WiMAX), Long Term Evolution (LTE) networks, 5G/3GPP (fifth-generation technology standard for broadband cellular networks/3^{rd} Generation Partnership Project) or any further generation, code division multiple access (CDMA), wideband code division multiple access (WCDMA), wireless fidelity (Wi-Fi), wireless LAN (WLAN), Bluetooth®, UWB (Ultra-wideband), Internet Protocol (IP) data casting, satellite, mobile ad-hoc network (MANET), and the like, or any combination thereof.

In one example, the system 100 or any of its components may be a platform with multiple interconnected components (e.g., a distributed framework). The system 100 and/or any of its components may include multiple servers, intelligent networking devices, computing devices, components, and corresponding software for spatial-temporal authentication. In addition, it is noted that the system 100 or any of its components may be a separate entity, a part of the one or more services, a part of a services platform, or included within other devices, or divided between any other components.

By way of example, the components of the system 100 can communicate with each other and other components external to the system 100 using well known, new or still developing protocols. In this context, a protocol includes a set of rules defining how the network nodes, e.g. the components of the system 100, within the communications network interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically affected by exchanging discrete packets of data. The packets typically comprise (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

The processes described herein for providing neuro-symbolic expert ML model selection may be advantageously implemented via software, hardware (e.g., general processor, memory, input/output interface, etc.), firmware, circuitry, or a combination thereof. Such exemplary hardware for performing the described functions is detailed below.

FIG. 9 illustrates an example computer system 900 upon which embodiments of the invention as described with the processes described herein may be implemented. The computer system 900 is programmed (e.g., via computer program code or instructions) to provide neuro-symbolic expert ML model selection as described herein and includes a communication mechanism such as a bus 910 for passing information between other internal and external components of the computer system 900. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 910 includes one or more parallel conductors of information so that information is transferred quickly among devices coupled to the bus 910. One or more processors 902 for processing information are coupled with the bus 910.

A processor 902 performs a set of operations on information as specified by computer program code related to providing neuro-symbolic expert ML model selection. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations includes bringing information in from the bus 910 and placing information on the bus 910. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 902, such as a sequence of operation codes, constitute processor instructions, also called computer system instructions or, simply, computer instructions. Processors may be implemented as mechanical, electrical, magnetic, optical, chemical or quantum components, among others, alone or in combination.

The computer system 900 also includes a memory 904 coupled to bus 910. The memory 904, such as a random access memory (RAM) or other dynamic storage device, stores information including processor instructions for providing neuro-symbolic expert ML model selection. Dynamic memory allows information stored therein to be changed by the computer system 900. RAM allows a unit of information stored at a location called a memory address to be stored and retrieved independently of information at neighboring addresses. The memory 904 is also used by the processor 902 to store temporary values during execution of processor instructions. The computer system 900 also includes a read only memory (ROM) 906 or other static storage device coupled to the bus 910 for storing static information, including instructions, that is not changed by the computer system 900. Some memory is composed of volatile storage that loses the information stored thereon when power is lost. Also coupled to bus 910 is a non-volatile (persistent) storage device 908, such as a magnetic disk, optical disk or flash card, for storing information, including instructions, that persists even when the computer system 900 is turned off or otherwise loses power.

Information, including instructions for providing neuro-symbolic expert ML model selection, is provided to the bus 910 for use by the processor from an external input device 912, such as a keyboard containing alphanumeric keys operated by a human user, or one or more sensors. In one embodiment, the computer system 900 includes or otherwise has access to one or more sensors 914 which detect conditions in its vicinity and transforms those detections into physical expression compatible with the measurable phenomenon used to represent information in the computer system 900. Examples of sensors 914 include but are not limited to cameras, Lidar, positioning sensors, gyroscopes, accelerometers, and/or the like. Other external devices coupled to bus 910, include one or more actuators 916. By way of example, an actuator is a device that converts electrical signals (e.g., control signals) into physical actions, such as movement, rotation, or force. In a mobile robot or equivalent drivetrain, an actuator 916 can be used to control the wheels that enable the robot to perform various maneuvers. For example, an actuator 916 can regulate the speed and direction of the wheels. Actuators 916 can be powered by different sources, such as but not limited to electricity, pneumatic pressure, or hydraulic fluid. Some examples of actuators 916 include but are not limited to motors, solenoids, cylinders, and servos. In some embodiments, for example, in embodiments in which the computer system 900 performs all functions automatically without human input, one or more of external input device 912, display device 914 and pointing device 916 is omitted. In various embodiments, the computer system 900 is further connected via the bus 910 to a one or more camera device, flash device or Lidar device.

Computer system 900 also includes one or more instances of a communications interface 970 coupled to bus 910. Communication interface 970 provides a one-way or two-way communication coupling to a variety of external devices that operate with their own processors, such as printers, scanners and external disks. In general, the coupling is with a network link 978 that is connected to a local network 980 to which a variety of external devices with their own processors are connected. In certain embodiments, the communications interface 970 enables connection to the communications network 107 for providing neuro-symbolic expert ML model selection.

The term computer-readable medium is used herein to refer to any medium that participates in providing information to processor 902, including instructions for execution. Such a medium may take many forms, including, but not limited to, non-volatile media, volatile media and transmission media. Non-volatile media include, for example, optical or magnetic disks, such as storage device 908. Volatile media include, for example, dynamic memory 904. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, any solid state medium, any magnetic medium, any optical medium, any physical medium, a RAM, any other memory chip, a carrier wave, or any other medium from which a computer can read.

Network link 978 typically provides information communication using transmission media through one or more networks to other devices that use or process the information. For example, network link 978 may provide a connection through local network 980 to a host computer 982 or to equipment 984 operated by an Internet Service Provider (ISP). ISP equipment 984 in turn provides data communication services through the public, world-wide packet-switching communications network of networks now commonly referred to as the Internet 990.

A computer called a server host 992 connected to the Internet hosts a process that provides a service in response to information received over the Internet. For example, server host 992 hosts a process that provides information representing video data for presentation at display 914. It is contemplated that the components of the system 100 can be deployed in various configurations within other computer systems, e.g., host 982 and server 992.

FIG. 10 illustrates a chip set 1000 upon which embodiments of the invention, for example, the components of system 100 may be implemented. The chip set 1000 is programmed to provide neuro-symbolic expert ML model selection as described herein. By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 1000 includes a communication mechanism such as an input/output (I/O) interface 1001 for passing information among the components of the chip set 1000 and to external devices (e.g., sensors and/or actuators of a robot, transmitters/receivers for signaling a vehicle/robot/drivetrain or component thereof, etc.). A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. Other specialized components to aid in performing the inventive functions described herein include one or more field programmable gate arrays (FPGA) (not shown), one or more controllers (not shown), or one or more other special-purpose computer chips.

The processor 1003 and accompanying components have connectivity to the memory 1005 via the I/O interface 1001. The memory 1005 includes both dynamic memory (e.g., RAM, magnetic disk, writable optical disk, etc.) and static memory (e.g., ROM, CD-ROM, etc.) for storing executable instructions that when executed perform the inventive steps described herein to provide neuro-symbolic expert ML model selection. The memory 1005 also stores the data associated with or generated by the execution of the inventive steps.

What is claimed is:

1. An apparatus comprising:
at least one processor; and
at least one memory storing instructions that, when executed by the at least one processor, cause the apparatus at least to perform:
applying a first machine learning model to perform a first keypoint extraction and/or a first detection of at least one object of one or more object classes in image data;
querying a database of a plurality of expert models for a second machine learning model based on the one or more object classes of the first keypoint extraction and/or the first detection, wherein the second machine learning model is an expert model trained to detect the one or more object classes or another object class related to the one or more object classes, and wherein the database corresponds to a hierarchical structure that relates the plurality of expert models based, at least in part, on a plurality of object class labels; and
applying the second machine learning model to perform a second keypoint extraction and/or a second detection of the at least one object of the one or more object classes in the image data.

2. The apparatus of claim 1, wherein the hierarchical structure is based, at least in part, on a generality of the plurality of object class labels.

3. The apparatus of claim 1, wherein the hierarchical structure is based, at least in part, on one or more characteristics which can describe the one or more object classes.

4. The apparatus of claim 1, wherein the instructions, when executed by the processor, further cause the apparatus to perform:
querying the database for the expert model from a hierarchical parent or a hierarchical child of the one or more object classes in the hierarchical structure based, at least in part, on determining that the one or more object classes of the first detection does not have an available expert model in the database.

5. The apparatus of claim 1, wherein the first detection includes one or more regions of interest in the image data that are associated with the one or more object classes, and wherein the second machine learning model is applied to the one or more regions of interest to perform the second detection.

6. The apparatus of claim 1, wherein the first machine learning model, the second machine learning model, or a combination thereof are further trained to detect one or more keypoints associated with the one or more object classes.

7. The apparatus of claim 6, wherein the one or more keypoints are used for simultaneous localization and mapping (SLAM) processing.

8. The apparatus of claim 1, wherein the instructions, when executed by the processor, further cause the apparatus to perform:
creating a knowledge graph of the one or more objects based, at least in part, on the first detection,
wherein the querying of the database is based, at least in part, on the knowledge graph.

9. The apparatus of claim 8, wherein the knowledge graph summarizes on or more relationships of one or more detected objects of the one or more object classes.

10. The apparatus of claim 9, wherein the knowledge graph is reduced to the one or more object classes.

11. The apparatus of claim 10, wherein the querying of the database is based, at least in part, on the reduced knowledge graph.

12. A method comprising:
applying a first machine learning model to perform a first keypoint extraction and/or a first detection of at least one object of one or more object classes in image data;
querying a database of a plurality of expert models for a second machine learning model based on the one or more object classes of the first keypoint extraction and/or the first detection, wherein the second machine learning model is an expert model trained to detect the one or more object classes or another object class related to the one or more object classes, and wherein the database corresponds to a hierarchical structure that relates the plurality of expert models based, at least in part, on a plurality of object class labels; and
applying the second machine learning model to perform a second keypoint extraction and/or a second detection of the at least one object of the one or more object classes in the image data.

13. The method of claim 12, wherein the hierarchical structure is based, at least in part, on a generality of the plurality of object class labels.

14. The method of claim 12, wherein the hierarchical structure is based, at least in part, on one or more characteristics which can describe the one or more object classes.

15. The method of claim 12, further comprising:
querying the database for the expert model from a hierarchical parent or a hierarchical child of the one or more object classes in the hierarchical structure based, at least in part, on determining that the one or more object classes of the first detection does not have an available expert model in the database.

16. The method of claim 12, wherein the first detection includes one or more regions of interest in the image data that are associated with the one or more object classes, and wherein the second machine learning model is applied to the one or more regions of interest to perform the second detection.

17. The method of claim 12, wherein the first machine learning model, the second machine learning model, or a combination thereof are further trained to detect one or more keypoints associated with the one or more object classes.

18. The method of claim 17, wherein the one or more keypoints are used for simultaneous localization and mapping (SLAM) processing.

19. The method of claim 12, further comprising:
creating a knowledge graph of the one or more objects based, at least in part, on the first detection,
wherein the querying of the database is based, at least in part, on the knowledge graph.

20. A non-transitory computer readable medium comprising instructions, when executed by an apparatus, cause the apparatus to perform:
applying a first machine learning model to perform a first keypoint extraction and/or a first detection of at least one object of one or more object classes in image data;
querying a database of a plurality of expert models for a second machine learning model based on the one or more object classes of the first keypoint extraction and/or the first detection, wherein the second machine learning model is an expert model trained to detect the one or more object classes or another object class related to the one or more object classes, and wherein the database corresponds to a hierarchical structure that relates the plurality of expert models based, at least in part, on a plurality of object class labels; and
applying the second machine learning model to perform a second keypoint extraction and/or a second detection of the at least one object of the one or more object classes in the image data.
